(19) United States
(12) Patent Application Publication
(10) Pub. No.: US 2023/0197332 A1
(43) Pub. Date: Jun. 22, 2023

(54) COIL COMPONENT

(71) Applicant: SAMSUNG ELECTRO-MECHANICS CO., LTD., Suwon-si (KR)

(72) Inventor: So Young Jun, Suwon-si (KR)

(73) Assignee: SAMSUNG ELECTRO-MECHANICS CO., LTD., Suwon-si (KR)

(21) Appl. No.: 17/891,572

(22) Filed: Aug. 19, 2022

(30) Foreign Application Priority Data
Dec. 20, 2021 (KR) 10-2021-0182613

(51) Int. Cl. H01F 27/29; H01F 27/32; H01F 17/04

(52) U.S. Cl. CPC H01F 27/292; H01F 27/324; H01F 17/045; H01F 2017/048

(57) ABSTRACT

A coil component includes: a body; a coil unit disposed in the body; external electrodes disposed on the body and connected to the coil unit; and a surface insulating layer disposed on the body, and including inorganic fillers with fluorine coating layers formed on surfaces thereof.

### CROSS-REFERENCE TO RELATED APPLICATION(S)

This application claims benefit of priority to Korean Patent Application No. 10-2021-0182613 filed on Dec. 20, 2021 in the Korean Intellectual Property Office, the disclosure of which is incorporated herein by reference in its entirety.

### TECHNICAL FIELD

The present disclosure relates to a coil component.

### BACKGROUND

An inductor, a coil component, is a typical passive electronic component used in an electronic device together with a resistor and a capacitor.

In a general coil component, a body is formed with a coil unit disposed therein, external electrodes are formed on surfaces of the body, and the other surfaces of the body, on which the external electrode are not formed, are covered by an insulating layer.

As electronic devices are increasingly improved in performance while their sizes become smaller, the number of electronic components used in the electronic devices has increased, and the sizes of the electronic components have decreased. Due to the reduction in the size of the component, the insulating layer is also formed to be thin. When the component is used as an electric part, the insulating layer needs to have strong moisture resistance.

### SUMMARY

An aspect of the present disclosure may provide a coil component having improved moisture resistance.

Another aspect of the present disclosure may provide a coil component including a surface insulating layer having a reduced thickness while having strong moisture resistance.

According to an aspect of the present disclosure, a coil component may include: a body; a coil unit disposed in the body; external electrodes disposed on the body and connected to the coil unit; and a surface insulating layer disposed on the body, and including inorganic fillers with fluorine coating layers disposed on surfaces thereof.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a coil component according to a first exemplary embodiment in the present disclosure;

FIG. 2 is a schematic cross-sectional view of FIG. 1 taken along line I-I′;

FIG. 3 is an enlarged view of region A of FIG. 2;

FIG. 4 is a schematic cross-sectional view of FIG. 1 taken along line II-II′;

FIG. 5 is a schematic perspective view illustrating a coil component according to a second exemplary embodiment in the present disclosure;

FIG. 6 is a schematic perspective view illustrating a coil component according to a third exemplary embodiment in the present disclosure;

FIG. 7 is a schematic cross-sectional view of FIG. 6 taken along line III-III′;

FIG. 8 is a schematic perspective view illustrating a coil component according to a fourth exemplary embodiment in the present disclosure;

FIG. 9 is a schematic perspective view illustrating a coil component according to a fifth exemplary embodiment in the present disclosure; and

FIG. 10 is a bottom view of FIG. 9 when viewed from direction B.

### DETAILED DESCRIPTION

Hereinafter, exemplary embodiments in the present disclosure will now be described in detail with reference to the accompanying drawings.

In the drawings, an L direction may be defined as a first direction or a length direction, a W direction may be defined as a second direction or a width direction, and a T direction may be defined as a third direction or a thickness direction.

Various kinds of electronic components may be used in electronic devices, and various kinds of coil components may be appropriately used between these electronic components to remove noise or for other purposes.

That is, in the electronic devices, the coil components may be used as power inductors, high frequency (HF) inductors, general beads, high frequency (GHz) beads, common mode filters, and the like.

### First Exemplary Embodiment

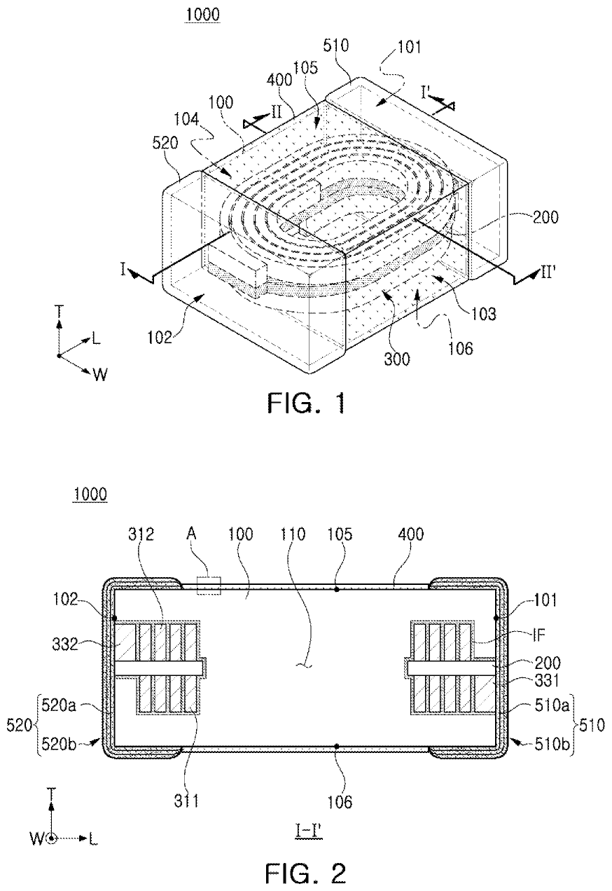

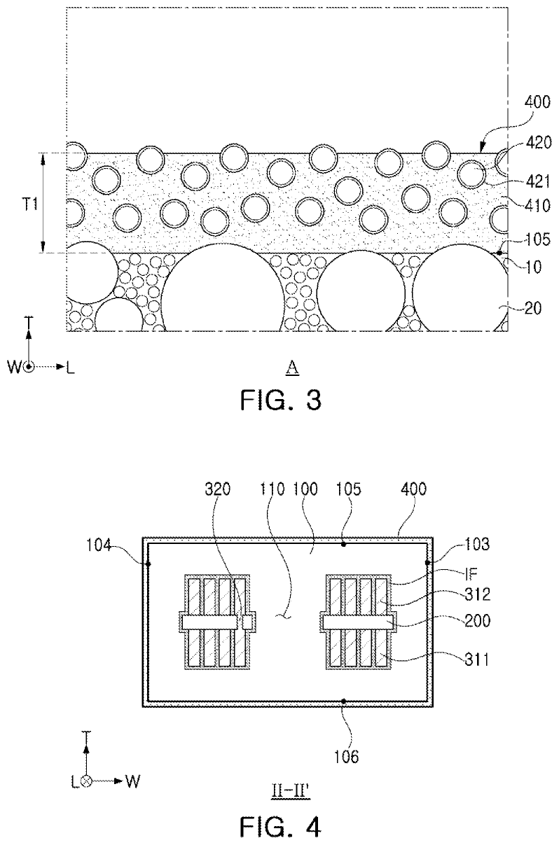

FIG. 1 is a schematic perspective view illustrating a coil component according to a first exemplary embodiment in the present disclosure. FIG. 2 is a schematic cross-sectional view of FIG. 1 taken along line I-I′. FIG. 3 is an enlarged view of region A of FIG. 2. FIG. 4 is a schematic cross-sectional view of FIG. 1 taken along line II-II′.

Referring to FIGS. 1 and 2, the coil component 1000 according to the first exemplary embodiment in the present disclosure may include a body 100, a coil unit 300, a surface insulating layer 400, and external electrodes 510 and 520, and may further include a substrate 200.

The body 100 may form an appearance of the coil component 1000 according to the present exemplary embodiment, and the coil unit 300 and the substrate 200 may be disposed in the body 100.

The body 100 may generally have a hexahedral shape

Based on FIGS. 1 and 2, the body 100 may have a first surface 101 and a second surface 102 facing each other in the length direction L, a third surface 103 and a fourth surface 104 facing each other in the width direction W, and a fifth surface 105 and a sixth surface 106 facing each other in the thickness direction T. The first to fourth surfaces 101 to 104 of the body 100 may connect the fifth surface 105 and the sixth surface 106 of the body 100 to each other. The sixth surface 106 of the body 100 may be used as a mounting surface when the coil component 1000 according to the present exemplary embodiment is mounted on a mounting board such as a printed circuit board.

The body 100 may be formed so that the coil component 1000 according to the present exemplary embodiment in which the surface insulating layer 400 and the external electrodes 510 and 520 to be described below are formed, for example, has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.5 mm, or has a length of 0.8 mm, a width of 0.4 mm, and a thickness of 0.65 mm, but is not limited thereto. Meanwhile, the above-described exemplary numerical values for the length, width, and thickness of the coil component 1000 refer to numerical values in which process errors are not reflected. Thus, numerical values including process errors in an allowable range may be considered to fall within the above-described exemplary numerical values.

Based on an image of a cross section of the coil component 1000 in the length direction L-thickness direction T taken at a central portion thereof in the width direction W using an optical microscope or a scanning electron microscope (SEM), the above-mentioned length of the coil component 1000 may refer to a maximum value among dimensions of a plurality of line segments spaced apart from each other in the thickness direction T, each connecting two outermost boundary lines facing each other in the length direction L of the coil component 1000 in parallel to the length direction L in the image. Alternatively, the length of the coil component 1000 may refer to a minimum value among the dimensions of the plurality of line segments described above. Alternatively, the length of the coil component 1000 may refer to an arithmetic mean value of at least three among the dimensions of the plurality of line segments described above. Here, the plurality of line segments parallel to the length direction L may be equally spaced from each other in the thickness direction T, but the scope of the present disclosure is not limited thereto.

Based on an image of a cross section of the coil component 1000 in the length direction L-thickness direction T taken at a central portion thereof in the width direction W using an optical microscope or a scanning electron microscope (SEM), the above-mentioned thickness of the coil component 1000 may refer to a maximum value among dimensions of a plurality of line segments spaced apart from each other in the length direction L, each connecting two outermost boundary lines facing each other in the thickness direction T of the coil component 1000 in parallel to the thickness direction T in the image. Alternatively, the thickness of the coil component 1000 may refer to a minimum value among the dimensions of the plurality of line segments described above. Alternatively, the thickness of the coil component 1000 may refer to an arithmetic mean value of at least three among the dimensions of the plurality of line segments described above. Here, the plurality of line segments parallel to the thickness direction T may be equally spaced from each other in the length direction L, but the scope of the present disclosure is not limited thereto.

Based on an image of a cross section of the coil component 1000 in the length direction L-width direction W taken at a central portion thereof in the thickness direction T using an optical microscope or a scanning electron microscope (SEM), the above-mentioned width of the coil component 1000 may refer to a maximum value among dimensions of a plurality of line segments spaced apart from each other in the length direction L, each connecting two outermost boundary lines facing each other in the width direction W of the coil component 1000 in parallel to the width direction W in the image. Alternatively, the width of the coil component 1000 may refer to a minimum value among the dimensions of the plurality of line segments described above. Alternatively, the width of the coil component 1000 may refer to an arithmetic mean value of at least three among the dimensions of the plurality of line segments described above. Here, the plurality of line segments parallel to the width direction W may be equally spaced from each other in the length direction L, but the scope of the present disclosure is not limited thereto.

Alternatively, each of the length, width, and thickness of the coil component 1000 may be measured by a micrometer measurement method. In the micrometer measurement method, each of the length, width, and thickness of the coil component 1000 may be measured by setting a zero point using a micrometer having gage repeatability and reproducibility (R&R), inserting the coil component 1000 according to the present exemplary embodiment between tips of the micrometer, and turning a measurement lever of the micrometer. Meanwhile, concerning the measurement of the length of the coil component 1000 by the micrometer measurement method, the length of the coil component 1000 may refer to a value measured once, or may refer to an arithmetic mean of values measured multiple times. The same may also be applied to the width and the thickness of the coil component 1000.

The body 100 may have a core 111 penetrating through central portions of the substrate 200 and the coil unit 300 to be described below. When the body 100 is formed by stacking at least one magnetic composite sheet including a metal magnetic powder and an insulating resin on upper and lower sides of the coil unit 300, the core 111 may be formed by filling a through hole formed in the central portion of the coil unit 300 with the magnetic composite sheet, but is not limited thereto.

The body 100 may include an insulating resin 10 and magnetic metal particles 20. Specifically, the body 100 may be formed by stacking one or more magnetic composite sheets including an insulating resin and a magnetic metal powder dispersed in the insulating resin. The magnetic metal powder of the magnetic composite sheet may become magnetic metal particles 20 of the body 100 through a subsequent process.

The insulating resin 10 may include an epoxy, a polyimide, a liquid crystal polymer (LCP), or a mixture thereof, but is not limited thereto.

The magnetic metal particles 20 may include one or more selected from the group consisting of iron (Fe), silicon (Si), chromium (Cr), cobalt (Co), molybdenum (Mo), aluminum (Al), niobium (Nb), copper (Cu), boron (B), and nickel (Ni). For example, the magnetic metal particles 20 may be formed by using one or more of pure iron powder, an Fe-Si-based alloy powder, an Fe-Si-Al-based alloy powder, an Fe-Ni-based alloy powder, an Fe-Ni-Mo-based alloy powder, an Fe-Ni-Mo-Cu-based alloy powder, an Fe-Co-based alloy powder, an Fe-Ni-Co-based alloy powder, an Fe-Cr-based alloy powder, an Fe-Cr-Si-based alloy powder, an Fe-Si-Cu-Nb-based alloy powder, an Fe-Ni-Cr-based alloy powder, and an Fe-Cr-Al-based alloy powder.

The magnetic metal particles 20 may be amorphous or crystalline. For example, the magnetic metal particles 20 may be an Fe-Si-based amorphous alloy powder, but is not necessarily limited thereto. The magnetic metal particles 20 may have an average diameter of about 0.1 μm to 30 μm, but is not limited thereto. Meanwhile, in the present specification, the diameter may refer to a particle size distribution expressed as D₉₀, D₅₀, or the like.

The body 100 may include two or more types of magnetic metal particles 20 dispersed in the resin. Here, the different types of magnetic metal particles 20 mean that the magnetic metal particles 20 dispersed in the resin are distinguished from each other in terms of any one of average particle diameter, composition, crystallinity, and shape.

The substrate 200 may be disposed inside the body 100. The substrate 200 may be configured to support the coil unit 300 to be described below.

The substrate 200 may be formed of an insulating material including a thermosetting insulating resin such as an epoxy resin, a thermoplastic insulating resin such as a polyimide resin, or a photosensitive insulating resin, or may be formed of an insulating material in which a reinforcing material such as a glass fiber or a filler is impregnated in such an insulating resin. As an example, the substrate 200 may be formed of an insulating material such as prepreg, an Ajinomoto build-up film (ABF), FR-4, a bismaleimide triazine (BT) resin, or a photoimageable dielectric (PID), but is not limited thereto.

The filler may be at least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the substrate 200 is formed of an insulating material including a reinforcing material, the substrate 200 may provide more excellent rigidity. When the substrate 200 is formed of an insulating material including no glass fiber, this may be advantageous in decreasing a thickness of the coil component 1000 according to the present exemplary embodiment. In addition, based on the body 100 of the same size, the substrate 200 formed of an insulating material including no glass fiber makes it possible to increase a volume occupied by the coil unit 300 and/or the magnetic metal powder, thereby improving component characteristics. When the substrate 200 is formed of an insulating material including a photosensitive insulating resin, the number of processes for forming the coil unit 300 may decrease, which is advantageous in decreasing a production cost and in forming a fine via 320.

The substrate 200 may have a thickness of, for example, 10 μm or more and 50 μm or less, but is not limited thereto.

The coil unit 300 may be disposed inside the body 100 to exhibit characteristics of the coil component. For example, when the coil component 1000 according to the present exemplary embodiment is utilized as a power inductor, the coil unit 300 may serve to stabilize power of an electronic device by storing an electric field as a magnetic field and maintaining an output voltage.

Referring to FIGS. 1 through 4, the coil unit 300 may include coil patterns 311 and 312, lead-out portions 331 and 332, and a via 320. Specifically, based on the directions of FIGS. 2 and 4, a first coil pattern 311 and a first lead-out portion 331 may be disposed on a lower surface of the substrate 200 facing the sixth surface 106 of the body 100, and a second coil pattern 312 and a second lead-out portion 332 may be disposed on an upper surface of the substrate 200 facing the lower surface of the substrate 200. The first coil pattern 311 may be connected in contact with the first lead-out portion 331 on the lower surface of the substrate 200. The second coil pattern 312 may be connected in contact with the second lead-out portion 332 on the upper surface of the substrate 200, and the via 320 may be connected in contact with respective inner ends of the first coil pattern 311 and the second coil pattern 312 by penetrating through the substrate 200. By doing so, the coil unit 300 may function as a single coil as a whole.

Each of the first coil pattern 311 and the second coil pattern 312 may have a planar spiral shape in which at least one turn is formed around the core 111. As an example, the first coil pattern 311 may form at least one turn around the core 111 on the lower surface of the substrate 200.

The lead-out portions 331 and 332 may be exposed to (or extend from) the first and second surfaces 101 and 102 of the body 100, respectively. That is, the first lead-out portion 331 may be exposed to (or extend from) the first surface 101 of the body 100, and the second lead-out portion 332 may be exposed to (or extend from) the second surface 102 of the body 100.

At least one of the coil patterns 311 and 312, the via 320, and the lead-out portions 331 and 332 may include at least one conductive layer. For example, based on the directions of FIGS. 2 and 4, when the second coil pattern 312, the via 320, and the second lead-out portion 332 are formed on the upper surface of the substrate 200 by plating, each of the second coil pattern 312, the via 320, and the second lead-out portion 332 may include a seed layer such as an electroless plating layer and an electrolytic plating layer. Here, the electrolytic plating layer may have a single-layer structure or have a multi-layer structure. The electrolytic plating layer having the multi-layer structure may be formed in a conformal film structure in which one electrolytic plating layer covers another electrolytic plating layer, or may be formed by stacking one electrolytic plating layer on only one surface of another electrolytic plating layer. The seed layer of the second coil pattern 312, the seed layer of the via 320, and the seed layer of the second lead-out portion 332 may be integrally formed, such that no boundaries are formed therebetween, but are not limited thereto. The electrolytic plating layer of the second coil pattern 312, the electrolytic plating layer of the via 320, and the electrolytic plating layer of the second lead-out portion 332 may be integrally formed, such that no boundaries are formed therebetween, but are not limited thereto.

Each of the coil patterns 311 and 312, the via 320, and the lead-out portions 331 and 332 may be formed of a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, but is not limited thereto. As an example, the first coil pattern 311 may include a seed layer including copper (Cu) in contact with the substrate 200, and an electrolytic plating layer disposed on the seed layer and including copper (Cu), but the scope of the present disclosure is not limited thereto.

An insulating film IF may be disposed between the coil unit 300 and the body 100 and between the substrate 200 and the body 100.

Referring to FIGS. 2 and 4, the insulating film IF may formed along the surfaces of the substrate 200 on which the first and second coil patterns 311 and 312 and the first and second lead-out portions 331 and 332 are formed, but is not limited thereto. The insulating film IF may be filled between adjacent turns of each of the first and second coil patterns 311 and 312, between the first lead-out portion 331 and the first coil pattern 311, and between the second lead-out portion 332 and the second coil pattern 312 for insulation between coil turns.

The insulating film IF may be provided to insulate the coil unit 300 and the body 100 from each other, and may include a known insulating material such as parylene, but is not limited thereto. As another example, the insulating film IF may include an insulating material such as an epoxy resin rather than parylene. The insulating film IF may be formed by a vapor deposition method, but is not limited thereto. As another example, the insulating film IF may be formed by stacking insulation films for forming the insulating film IF on both surfaces of the substrate 200 on which the coil unit 300 is formed and then curing the insulation films, or may be formed by applying an insulation paste for forming the insulating film IF onto both surfaces of the substrate 200 on which the coil unit 300 is formed and then curing the insulation paste. Meanwhile, the insulating film IF may be omitted in the present exemplary embodiment for the above-described reason. That is, if the body 100 has a sufficient electrical resistance at an operating current and voltage designed for the coil component 1000 according to the present exemplary embodiment, the insulating film IF may be omitted in the present exemplary embodiment.

The surface insulating layer 400 may function to electrically protect the coil component, reduce a leakage current, and prevent plating spread at the time of forming the external electrodes 510 and 520 to be described below. In particular, the surface insulating layer 400 according to the present disclosure may include inorganic fillers 420 with fluorine coating layers 421 formed on surfaces thereof to enhance the moisture resistance of the coil component 1000.

Referring to FIGS. 1 through 4, the surface insulating layer 400 may be disposed on the surfaces of the body 100.

Specifically, the surface insulating layer 400 may be disposed on the first to sixth surfaces 101 to 106 of the body 100, except for regions where the external electrodes 510 and 520 to be described below are disposed. The surface insulating layer 400 may cover an entirety of regions where the first and second external electrodes are not disposed. The surface insulating layer 400 may function as a plating resist at the time of forming at least some of each of the external electrodes 510 and 520 to be described below by plating, but is not limited thereto. In some embodiments, the surface insulating layer 400 may not be disposed on the lead-out portions 331 and 332.

Referring to FIG. 3, the surface insulating layer 400 may include an insulating resin 410 and inorganic fillers 420 dispersed in the insulating resin 410.

The insulating resin 410 may include an epoxy, a polyimide, a liquid crystal polymer (LCP), or a mixture thereof, but is not limited thereto. The insulating resin 410 of the surface insulating layer 400 may include a resin that is identical or similar to the insulating resin 10 of the body 100. In this case, it is possible to increase a bonding force between the body 100 and the surface insulating layer 400.

Since the fluorine coating layers 421 having water repellency are formed on the surfaces of the inorganic fillers 420, the surface insulating layer 400 can be modified to have hydrophobicity, as a result enhancing the moisture resistance of the coil component 1000.

Referring to FIG. 3, the inorganic fillers 420 may be coated by the fluorine coating layers 421.

The inorganic fillers 420 may include at least one of silane (SiH₄), silica (SiO₂), and titanium oxide (TiO₂), and the fluorine coating layers 421 may include a fluorine (F) ingredient.

Referring to FIG. 3, some of the inorganic fillers 420 may be partially exposed outwardly from a surface of the insulating resin 410. In other words, some of the inorganic fillers 420 may partially protrude outwardly from the surface of the insulating resin 410.

Meanwhile, since the surfaces of the inorganic fillers 420 are covered by the fluorine coating layers 421, the fluorine coating layers 421 may be at least partially exposed from the surface of the insulating resin 410.

As some of the inorganic fillers 420 on which the fluorine coating layers 421 having water repellency are formed are exposed to the surface of the insulating resin 410, moisture resistance may be further improved in regions where the surface insulating layer 400 is formed.

A mean content ratio of fluorine (F) in the surface insulating layer 400 may be in a range of 1 wt % or more and 20 wt % or less, based on a total weight of atoms in the surface insulating layer, but is not limited thereto. The atoms in the surface insulating layer include atoms constituting the inorganic fillers and atoms constituting the surface insulating layer, and the atoms may include Si. Ti, O, and C.

When the mean content ratio of the fluorine (F) ingredient is less than 1 wt %, the fluorine coating layers 421 may not be sufficiently formed on the inorganic fillers 420, and a hydrophobic surface region of the surface insulating layer 400 may not be uniform, as a result deteriorating the moisture resistance of the coil component.

On the other hand, when the mean content ratio of the fluorine (F) ingredient is more than 20 wt %, the bonding strength between the surface insulating layer 400 and the body 100 may decrease.

Therefore, the mean content ratio of fluorine (F) in the surface insulating layer 400 is preferably in a range of 1 wt % or more and 20 wt % or less, but is not limited thereto.

Here, the mean content ratio of fluorine (F) in the surface insulating layer 400 may be calculated from an image observed using scanning electron microscope-energy dispersive x-ray spectroscopy (SEM-EDS). For example, an SEM image of a cross section (W-T cross section) of the coil component 1000 exposed in the width direction W-thickness direction T may be obtained by polishing the coil component 1000 up to a central portion thereof in the length direction L, and a mean value may be calculated by measuring fluorine (F) content ratios (wt %) in six regions of the surface insulating layer 400 shown in the SEM image using EDS. For example, the six regions may be selected to include three regions of the surface insulating layer 400 disposed on the fifth surface 105 of the body 100 and three regions of the surface insulating layer 400 disposed on the third surface 103 of the body 100. Each of the selected regions may be a region that is 40 μm in a horizontal direction (W direction) and 20 μm in a vertical direction (T direction), but is not limited thereto.

Referring to FIG. 3, the inorganic fillers 420 covered by the fluorine coating layers 421 may be formed in a spherical shape.

Here, the spherical shape may mean that the shape of the cross section is circular. In addition, the circular shape does not mean a circle in a mathematical sense, but includes a shape that may be recognized as a substantially circular shape in consideration of a difference in radius caused during a process or the like, such as a difference in a range of 10%.

Alternatively, the inorganic fillers 420 covered by the fluorine coating layers 421 may be formed in a flake shape.

Here, the flake shape may mean that the shape of the cross section has a major axis and a minor axis perpendicular to each other, the major axis being at least 5 times longer than the minor axis, but is not limited thereto.

Referring to FIG. 3, the surface insulating layer 400 may be formed to have a mean thickness T1 in a range of 1 μm or more and 10 μm or less (or in a range of 1 μm or more and less than 11 μm), but is not limited thereto.

When the mean thickness T1 of the surface insulating layer 400 is less than 1 μm, moisture penetration may occur in regions where the surface insulating layer 400 contacts protruding portions of the magnetic metal particles 20 of the body 100 toward the surface insulating layer 400, thereby deteriorating moisture resistance.

On the other hand, when the mean thickness T1 of the surface insulating layer 400 is more than 10 μm (or 11 μm or more), a volume of the body 100 may be relatively small as compared to an overall size of the coil component 1000, and accordingly, distances between the coil unit 300 and the surfaces of the body 100 may decrease, thereby deteriorating the moisture resistance of the coil component 1000 in a region where the surface insulating layer 400 is not disposed. Furthermore, the decrease in effective volume of the coil component 1000 may also deteriorate inductance characteristics.

TABLE 1

| | | Defect rate in | Whether reference |
|---|---|---|---|
| | Thickness | moisture | value for moisture |
| | of surface | resistance tests | resistance change |
| | insulating | (occurrence of | rate is satisfied |
| Experimental | layer | defects/the number | (Satisfied: OK/ |
| example | (μm) | of samples) | Unsatisfied: NG) |
| #1 | 0.3 | 20/30 | NG |
| #2 | 0.9 | 15/30 | NG |
| #3 | 2.9 | 0/30 | OK |
| #4 | 5.5 | 0/30 | OK |
| #5 | 10.1 | 0/30 | OK |
| #6 | 15.2 | 1/30 | NG |

Table 1 shows experimental data indicating results of moisture resistance tests (tests where the samples are left at a certain humidity and tests where the samples are subjected to changes in temperature and humidity) based on how thick the surface insulating layer 400 containing the inorganic fillers 420 is, with respect to the coil component 1000 according to the present exemplary embodiment.

Referring to Table 1, in Experimental Examples #1 and #2, where the mean thickness T1 of the surface insulating layer 400 was less than 1 μm, it was confirmed in the moisture resistance tests that a defect rate rapidly increased, and a moisture resistance change rate did not satisfy the reference value.

In addition, in Experimental Example #6, where the mean thickness T1 of the surface insulating layer 400 was more than 10 μm (or 11 μm or more), it was confirmed in the moisture resistance tests that a defect occurred and a moisture resistance change rate did not satisfy the reference value due to the decrease in volume of the body 100.

Therefore, in the coil component 1000 according to the present exemplary embodiment, when the surface insulating layer 400 is formed to have a mean thickness T1 in a range of 1 μm or more and 10 μm or less (or in a range of 1 μm or more and less than 11 μm), the moisture resistance may be improved, and the reference value for moisture resistance change rate may also be satisfied.

Here, based on an image of a cross section of the coil component 1000 in the length direction L-thickness direction T taken at a central portion thereof in the width direction W using an optical microscope or a scanning electron microscope (SEM), the mean thickness T1 of the surface insulating layer 400 may refer to an arithmetic mean value of at least three among dimensions of a plurality of line segments spaced apart from each other in the length direction L, each connecting two outermost boundary lines facing each other in the thickness direction T of the surface insulating layer 400 in parallel to the thickness direction T in the image. Here, the plurality of line segments parallel to the thickness direction T may be equally spaced from each other in the length direction L, but the scope of the present disclosure is not limited thereto. In addition, the outermost boundary line of the surface insulating layer 400 contacting the body 100 may include boundary lines along which the magnetic metal particles 20 included in the body 100 protrude toward the surface insulating layer 400, and also, the outermost boundary line of the surface insulating layer 400 facing outward may include boundary lines along which the inorganic fillers 420 included in the surface insulating layer 400 protrude outward.

The external electrodes 510 and 520 may be disposed on the surfaces of the body 100 and to be connected to the lead-out portions 331 and 332. Specifically, in the present exemplary embodiment, the first external electrode 510 may be disposed on the first surface 101 of the body 100 to be connected in contact with the first lead-out portion 331 of the coil unit 300 exposed to the first surface 101 of the body 100. The second external electrode 520 may be disposed on the second surface 102 of the body 100 to be connected in contact with the second lead-out portion 332 of the coil unit 300 exposed to the second surface 102 of the body 100.

Referring to FIGS. 1 and 2, the first external electrode 510 may be disposed on the first surface 101 of the body 100 and partially extend to the third to sixth surfaces 103 to 106 of the body 100. The second external electrode 520 may be disposed on the second surface 102 of the body 100 and partially extend to the third to sixth surfaces 103 to 106 of the body 100.

The external electrodes 510 and 520 may include first metal layers 510a and 520a contacting the lead-out portions 331 and 332, respectively, and second metal layers 510b and 520b disposed on the first metal layers 510a and 520a, respectively. The first metal layers 510a and 520a may be plating layers made of copper (Cu). In this case, the surface insulating layer 400 may function as a plating resist in a plating process for forming the first metal layers 510a and 520a. Alternatively, the first metal layers 510a and 520a may be conductive resin electrodes formed by applying a conductive paste including a conductive powder containing at least one of copper (Cu) and silver (Ag) and an insulating resin onto the body 100 and then curing the conductive paste. The second metal layers 510b and 520b may be disposed on the first metal layers 510a and 520a, and may include at least one of nickel (Ni) and tin (Sn). For example, each of the second metal layers 510b and 520b may include a nickel (Ni) plating layer and a tin (Sn) plating layer sequentially plated on each of the first metal layers 510a and 520a, but the scope of the present disclosure is limited thereto.

### Second and Third Exemplary Embodiments

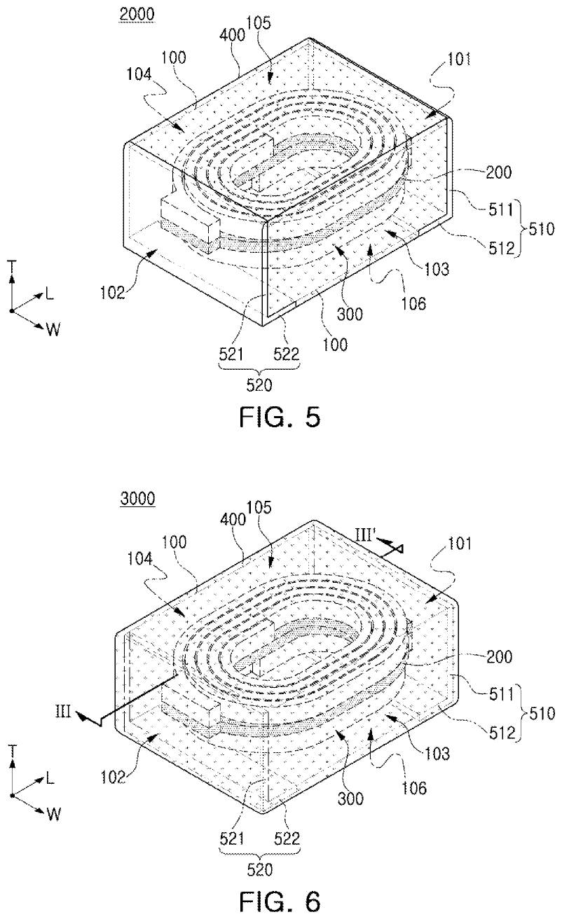

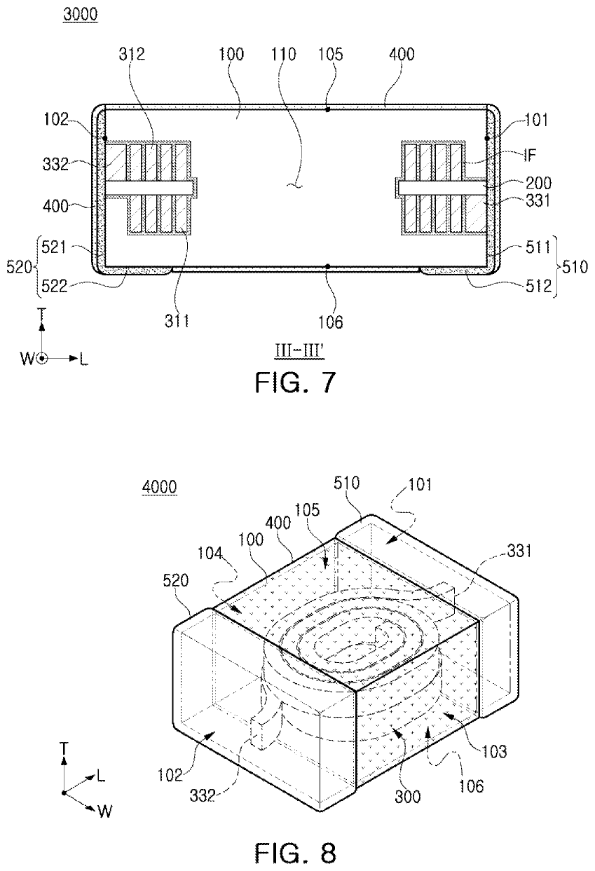

FIG. 5 is a schematic perspective view illustrating a coil component according to a second exemplary embodiment in the present disclosure. FIG. 6 is a schematic perspective view illustrating a coil component according to a third exemplary embodiment in the present disclosure. FIG. 7 is a schematic cross-sectional view of FIG. 6 taken along line III-III′.

Upon comparing FIGS. 5 through 7 with FIGS. 1 through 4, the coil components 2000 and 3000 according to the present exemplary embodiments are different from the coil component 1000 according to the first exemplary embodiment in the present disclosure in the shapes of the external electrodes 510 and 520 and the surface insulating layer 400 and the arrangement relationship between the external electrodes 510 and 520 and the surface insulating layer 400. Thus, in describing the coil components 2000 and 3000 according to the present exemplary embodiments, only the external electrodes 510 and 520 and the surface insulating layer 400, which are different from those in the coil component 1000 according to the first exemplary embodiment in the present disclosure, will be described. Concerning the other configuration of the present exemplary embodiments, what has been described above for the first exemplary embodiment in the present disclosure may be identically applied thereto.

Referring to FIG. 5, the external electrodes 510 and 520 may include connection portions 511 and 521 disposed on the first and second surfaces 101 and 102 of the body 100 and connected to the lead-out portions 331 and 332, respectively, and pad portions 512 and 522 disposed to extend from the connection portions 511 and 521, respectively, to the sixth surface 106 of the body 100, which is a mounting surface.

Specifically, the first external electrode 510 may include a first connection portion 511 disposed on the first surface 101 of the body 100 and connected in contact with the first lead-out portion 331, and a first pad portion 512 extending from the first connection portion 511 to the sixth surface 106 of the body 100.

The second external electrode 520 may include a second connection portion 521 disposed on the second surface 102 of the body 100 and connected in contact with the second lead-out portion 332, and a second pad portion 522 extending from the second connection portion 521 to the sixth surface 106 of the body 100.

The first pad portion 512 of the first external electrode 510 and the second pad portion 522 of the second external electrode 520 may be disposed to be spaced apart from each other on the sixth surface 106 of the body 100 so as not to contact each other.

The connection portions 511 and 521 and the pad portions 512 and 522 of the first and second external electrodes 510 and 520 may be formed by the same plating process, such that no boundaries are formed therebetween. That is, the first connection portion 511 and the first pad portion 512 may be integrally formed, and the second connection portion 521 and the second pad portion 522 may be integrally formed. In addition, the connection portions 511 and 521 and the pad portions 512 and 522 may be made of the same type of metal. However, the description herein does not exclude, from the scope of the present disclosure, a case in which the connection portions 511 and 521 and the pad portions 512 and 522 are formed by different plating processes and boundaries are formed therebetween.

Referring to FIG. 5, in the coil component 2000 according to the present exemplary embodiment, the surface insulating layer 400 may be disposed to entirely cover the third to fifth surfaces 103 to 105 of the body 100, and to cover a region where the pad portions 512 and 522 of the external electrodes 510 and 520 are not disposed on the sixth surface 106 of the body 100.

Referring to FIGS. 6 and 7, the coil component 3000 according to the third exemplary embodiment may include external electrodes 510 and 520 in the same form as the coil component 2000 according to the second exemplary embodiment. That is, the external electrodes 510 and 520 may include connection portions 511 and 521 disposed on the first and second surfaces 101 and 102 of the body 100 and connected to the lead-out portions 331 and 332, respectively, and pad portions 512 and 522 disposed to extend from the connection portions 511 and 521, respectively, to the sixth surface 106 of the body 100, which is a mounting surface.

In the coil component 3000 according to the present exemplary embodiment, after the external electrodes 510 and 520 are formed through a plating process, the surface insulating layer 400 may be additionally disposed on the first and second surfaces 101 and 102 of the body 100, and as a result, the external electrodes 510 and 520 may be exposed to the outside only in a direction toward the sixth surface 106 of the body 100, which is a mounting surface. In some embodiments, the surface insulating layer 400 may be disposed on at least one of the external electrodes 510 and 520.

The coil components 2000 and 3000 according to the second and third exemplary embodiments described above may have more improved inductance characteristics, as compared with the coil component 1000 according to the first exemplary embodiment, by reducing a volume occupied by the external electrodes 510 and 520 in the coil component of the same size to increase an effective volume of the coil component.

In particular, the coil component 3000 according to the third exemplary embodiment is capable of preventing a short circuit with an adjacent coil component when mounted on a circuit board (PCB), which is advantageous in size reduction and integration.

### Fourth and Fifth Exemplary Embodiments

FIG. 8 is a schematic perspective view illustrating a coil component 4000 according to a fourth exemplary embodiment in the present disclosure.

Upon comparing FIG. 8 with FIG. 1, the coil component 4000 according to the present exemplary embodiment is different in the configuration of the coil unit 300 depending on whether the substrate 200 is present or absent. Thus, in describing the present exemplary embodiment, only the coil unit 300, which is different from that in the coil component 1000 according to the first exemplary embodiment in the present disclosure, will be described. Concerning the other configuration of the present exemplary embodiment, what has been described above for the first exemplary embodiment in the present disclosure may be identically applied thereto.

Referring to FIG. 8, the coil component 4000 according to the present exemplary embodiment may include a wire-wound type coil unit 300. In this case, the substrate 200 is not included in the coil component 4000 according to the present exemplary embodiment.

The coil unit 300 may be a wire-wound coil formed by winding a metal wire such as a copper (Cu) wire of which a surface is coated with a coating layer. Therefore, an entire surface of each of a plurality of turns of the coil unit 300 may be coated with a coating layer.

Meanwhile, the metal wire may be a rectangular wire, but is not limited thereto. When the coil unit 300 is formed of a rectangular wire, each turn of the coil unit 300 may have a rectangular cross section.

The metal wire may be formed of a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, but is not limited thereto.

The coating layer may include an epoxy, a polyimide, a liquid crystal polymer (LCP), or a mixture thereof, but is not limited thereto.

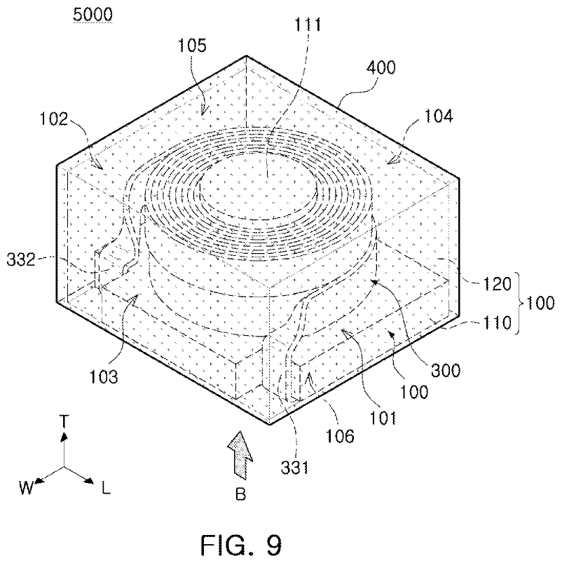

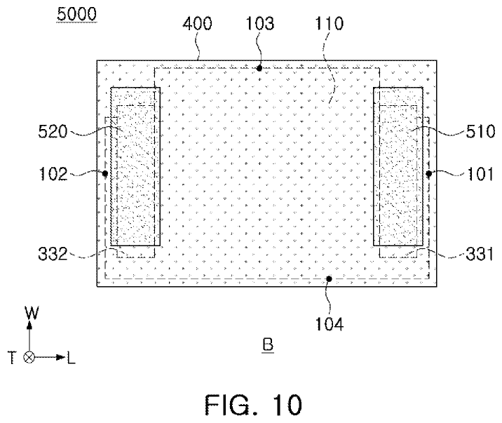

FIG. 9 is a schematic perspective view illustrating a coil component 5000 according to a fifth exemplary embodiment in the present disclosure. FIG. 10 is a bottom view of FIG. 9 when viewed from direction B.

Upon comparing FIGS. 9 and 10 with FIGS. 1 through 4, the coil component 5000 according to the present exemplary embodiment is different from the coil component 1000 according to the first exemplary embodiment in the present disclosure in the structure of the body 100, the surface of the body 100 to which the lead-out portions 331 and 332 are exposed, and the locations of the external electrodes 510 and 520. Thus, in describing the present exemplary embodiment, only the body 100 and the lead-out portions 331 and 332, which are different from those in the coil component 1000 according to the first exemplary embodiment in the present disclosure, will be described. Concerning the other configuration of the present exemplary embodiment, what has been described above for the first exemplary embodiment in the present disclosure may be identically applied thereto.

The body 100 applied to the coil component 5000 according to the present exemplary embodiment may include a mold portion 110 and a cover portion 120. Side surfaces of the mold portion 110 and the cover portion 120 may constitute the first to fourth surfaces 101 to 104 of the body 100, one surface of the cover portion 120 (an upper surface of the cover portion 120 based on the directions of FIGS. 9 and 10) may constitute the fifth surface 105 of the body 100, and the other surface of the mold portion 110 (a lower surface of the mold portion 110 based on the directions of FIGS. 9 and 10) may constitute the sixth surface 106 of the body 100. Hereinafter, the other surface of the mold portion 110 and the sixth surface of the body 100 may be used in the same meaning.

The mold portion 110 may include a base portion having one surface and the other surface facing each other, and a core 111 protruding from one surface of the base portion. The base portion may be configured to support the coil unit 300 disposed on one surface of the base portion. The core 111 may be disposed to protrude from one surface of the base portion. The core 111 may be disposed at a central portion on one surface of the base portion to penetrate through the coil unit 300.

Referring to FIG. 9, recess portions may be formed in the other surface of the base portion and in one side surface connecting one surface and the other surface to each other of the base portion to dispose the lead-out portions 331 and 332 extending from both ends of the coil unit 300 therein. The recess portions may be formed in both side corners of the base portion disposed in a direction in which the third surface 103 of the body 100 is connected to the first and second surfaces 101 and 102 of the body 100, respectively.

The recess portions may be formed in a shape corresponding to a shape of the lead-out portions 331 and 332. Meanwhile, the recess portions may be formed in a process of forming the mold portion 110 with a mold, or may be formed in the mold portion 110 in a process of pressing the cover portion 120. As another example, the lead-out portions 331 and 332 may penetrate through the mold portion 110 to be exposed to the other surface of the mold portion 110.

For example, the mold portion 110 may be formed using a mold having an inner space corresponding to the base portion and the core 111 in shape. The mold portion 110 may be formed by filling the mold with a composite material including a magnetic metal powder and an insulating resin. The metal magnetic powder of the composite material may be the magnetic metal particles 20 of the body 100. A process of applying a high temperature and a high pressure to the composite material in the mold may be additionally performed, but the formation of the mold portion is not limited thereto. The base portion and the core 111 may be integrally formed by the above-described process using a mold, such that no boundary is formed therebetween.

The cover portion 120 may be disposed on one surface of the mold portion 110 to cover the coil unit 300. The cover portion 120 may be formed by disposing magnetic composite sheets in which a magnetic metal powder is dispersed in an insulating resin on the mold portion 110 and the coil unit 300, and then heating and pressing the magnetic composite sheets. Through the above-described process, the mold portion 110 and the cover portion 120 may be integrated with each other so that a boundary therebetween is not identified without performing separate processing, but the scope of the present disclosure is not limited thereto.

The first and second lead-out portions 331 and 332 applied to the present exemplary embodiment may be exposed to the sixth surface 106 of the body 100 together, unlike those in the coil component 4000 according to the fourth exemplary embodiment in the present disclosure. That is, the first and second lead-out portions 331 and 332 may be disposed in the recess portions of the mold portion 110, and exposed to the sixth surface 106 of the body 100 while being spaced apart from each other.

Referring to FIG. 10, the surface insulating layer 400 may cover the first to sixth surfaces 101 to 106 of the body 100, but the surface insulating layer 400 may have openings formed therein to expose the first and second lead-out portions 331 and 332 exposed to the sixth surface 106 of the body 100. The external electrodes 510 and 520 may be disposed in the openings, such that the external electrodes 510 and 520 and the lead-out portions 331 and 332 are connected in contact with each other.

For example, as illustrated in FIG. 10, a dimension in the length direction L of each of the openings, in which the external electrodes 510 and 520 are disposed, may be larger than a dimension in the length direction L of each of the lead-out portions 331 and 332. Thus, each of the openings may further expose at least a portion of the sixth surface 106 of the body 100 as well as each of the lead-out portions 331 and 332.

The external electrodes 510 and 520 may be disposed only on the sixth surface 106 of the body 100. The external electrodes 510 and 520 may be disposed to be spaced apart from each other on the sixth surface 106 of the body 100.

As set forth above, according to the exemplary embodiments in the present disclosure, the moisture resistance of the coil component can be improved.

In addition, according to the exemplary embodiments in the present disclosure, the surface insulating layer can be implemented to have a reduced thickness while having strong moisture resistance, thereby making it possible to provide a coil component having a small size and a reduced thickness.

While exemplary embodiments have been shown and described above, it will be apparent to those skilled in the art that modifications and variations could be made without departing from the scope of the present invention as defined by the appended claims.

What is claimed is:

1. A coil component comprising:
a body;
a coil unit disposed in the body;
external electrodes disposed on the body and connected to the coil unit; and
a surface insulating layer disposed on the body, and including inorganic fillers with fluorine coating layers disposed on surfaces thereof.

2. The coil component of claim 1, wherein the surface insulating layer further includes an insulating resin, and
the inorganic fillers are disposed in the insulating resin.

3. The coil component of claim 2, wherein some of the inorganic fillers are partially exposed from a surface of the insulating resin.

4. The coil component of claim 3, wherein the fluorine coating layers on some of the inorganic fillers are at least partially exposed from the surface of the insulating resin.

5. The coil component of claim 2, wherein some of the inorganic fillers partially protrude from a surface of the insulating resin.

6. The coil component of claim 1, wherein a mean content ratio of fluorine (F) in the surface insulating layer is 1 wt % or more and 20 wt % or less.

7. The coil component of claim 1, wherein the inorganic fillers include at least one of silane (SiH₄), silica (SiO₂), and titanium oxide (TiO₂).

8. The coil component of claim 1, wherein the surface insulating layer has a mean thickness of 1 μm or more and 10 μm or less.

9. The coil component of claim 6, wherein the surface insulating layer has a mean thickness of 1 μm or more and 10 μm or less.

10. The coil component of claim 1, wherein the coil unit includes lead-out portions extending from one surface of the body.

11. The coil component of claim 1, further comprising a substrate disposed in the body, with the coil unit being disposed on at least one surface thereof.

12. The coil component of claim 11, further comprising an insulating film disposed between the coil unit and the body.

13. The coil component of claim 10, wherein the lead-out portions include a first lead-out portion extending from the one surface of the body, and a second lead-out portion extending from the other surface facing the one surface of the body, and
the external electrodes include a first external electrode disposed on the one surface of the body and connected to the first lead-out portion, and a second external electrode disposed on the other surface of the body and connected to the second lead-out portion.

14. The coil component of claim 13, wherein the surface insulating layer covers regions where the first and second external electrodes are not disposed on surfaces of the body.

15. The coil component of claim 14, wherein the surface insulating layer has a mean thickness of 1 μm or more and 10 μm or less.

16. The coil component of claim 13, wherein the body has a mounting surface connecting the one surface and the other surface of the body to each other,
the first and second external electrodes include first and second connection portions contacting the first and second lead-out portions, respectively, and first and second pad portions extending from the first and second connection portions, respectively, to the mounting surface of the body while being spaced apart from each other, and
the surface insulating layer covers the first and second connection portions.

17. The coil component of claim 16, wherein the surface insulating layer has a mean thickness of 1 μm or more and 10 μm or less.

18. The coil component of claim 10, wherein the lead-out portions include first and second lead-out portions extending from the one surface of the body while being spaced apart from each other, and the external electrodes include first and second external electrodes disposed on the one surface of the body while being spaced apart from each other, and connected to the first and second lead-out portions, respectively.

19. The coil component of claim 13, wherein each of the first and second external electrodes includes a first metal layer contacting each of the first and second lead-out portions, and a second metal layer disposed on the first metal layer.

20. The coil component of claim 1, wherein the coil unit is a wire-wound type coil.

21. The coil component of claim 1, wherein the surface insulating layer has a mean thickness of 1 μm or more and less than 11 μm.

22. The coil component of claim 1, wherein the surface insulating layer is disposed on at least one of the external electrodes.

23. The coil component of claim 10, wherein the surface insulating layer is not disposed on the lead-out portions.

24. The coil component of claim 14, wherein the surface insulating layer covers an entirety of the regions where the first and second external electrodes are not disposed.
